(19) United States
(12) Patent Application Publication
(10) Pub. No.: US 2006/0197979 A1
(43) Pub. Date: Sep. 7, 2006

(54) Image communication device

(75) Inventor: Shinji Kawasaki, Joyo-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: MURATA KIKAI KABUSHIKI KAISHA, Kyoto-shi (JP)

(21) Appl. No.: 11/362,841

(22) Filed: Feb. 28, 2006

(30) Foreign Application Priority Data
Aug. 24, 2005 (JP) 2005-242944
Aug. 22, 2005 (JP) 2005-240415
Aug. 22, 2005 (JP) 2005-240414
Mar. 1, 2005 (JP) 2005-055447

(51) Int. Cl. G06F 3/12

(52) U.S. Cl. 358/1.15

(57) ABSTRACT

An image communication device can transmit image data to a remote archive device. The image communication device can prevent transmission of the image data without an archive processing executed. The image communication device includes a transmission unit, an archive transmission unit and an archive processing control unit. The transmission unit transmits the image data to a prescribed destination. The archive transmission unit carries out an archive transmission of the image data, which has been transmitted to the destination by the transmission unit, to the remote archive device. The archive processing control unit suspends the transmission of the image data when receiving a transmission instruction of the image data under a state in which the archive transmission unit cannot carry out the archive transmission.

### BACKGROUND OF THE INVENTION

1. Field of the Invention

The present invention relates to an image communication device, and more particularly to an image communication device which transmits transmitted and/or received image data to an archive device other than the image communication device itself and saves the image data in the archive device.

2. Description of the Related Art

To manage transmitted and/or received image information, a conventional image communication device generates electronic mail (hereinafter “e-mail”) including the transmitted and/or received image information as an attached file, and transmits the e-mail to a remote device (for example, a file server).

For example, the conventional image communication device is a Group 3 (G3) facsimile (hereinafter “FAX”) machine, an Internet FAX (hereinafter “I-FAX”) machine, and a computer in which FAX software is installed. The conventional image communication device transmits and receives image information by using a G3 FAX communication technology or an I-FAX communication technology. The conventional image communication device generates communication history information of the transmitted and/or received image information, for example, transmission and/or reception date and time, another party of the transmission and/or the reception, or a circumstance of the transmission and/or the reception.

Another known conventional communication device stores image information in an image information storage unit. The communication device generates a Hyper Text Markup Language (HTML) file including a plurality of communication history information and a storage location of the image information expressed in a hyperlink form. A user opens the HTML file and searches communication history information of desired image information by using a browser. The user uses a hyperlink associated with the searched communication history information to acquire the image information stored in the image information storage unit.

An archive processing is carried out for a purpose of safely saving image data transmitted from an image communication device such as a FAX machine. The archive processing is also carried out for a purpose of monitoring image data transmitted by a user of the FAX machine. For example, when an employee transmits a confidential document from a FAX machine located in an office to an arbitrary destination, if the archive processing has been carried out, a history of the transmission can be acquired. When the FAX machine is set to carry out the archive processing for such a purpose, if image data is transmitted to a remote device without the archive processing being carried out, the FAX machine fails to monitor the transmitted image data.

A conventional communication device transmits image information by FAX communication, and then transmits e-mail including the transmitted image information as an attached file to a remote device. Therefore, even when the e-mail fails to be transmitted or saved due to, for example, trouble on a communication line or lack of storage capacity (memory capacity) of a transmission destination, and the image information fails to be saved, there are cases in which transmission of the image information by the FAX communication is completed. As a result, there existed a problem that the transmitted image information cannot be saved reliably.

In a conventional image communication device, when image information stored in an image information storage unit is moved to a different storage location, a hyperlink included in an HTML file is required to be changed, thus causing an inconvenience. Moreover, the conventional image communication device is required to generate one file including image information and communication history information. According to necessity, the conventional image communication device is required to extract the image information or the communication history information from the generated file. Thus, there existed a problem that processes of the image communication device become complicated.

### SUMMARY OF THE INVENTION

The present invention has been made in order to overcome the problems described above. An advantage of the present invention is to provide a technology for preventing image data from being transmitted without being executed with an archive processing.

Another advantage of the present invention is to provide a transmission device which saves transmission image information in a saving unit before transmitting the image information so that the image information can be transmitted after confirming that the saving of the image information has been completed.

Another advantage of the present invention is to provide a communication device which prohibits transmission and/or reception of image information when the communication device is not connected to a communication line for communicating with a saving unit so that the transmission and/or the reception of the image information can be prevented when the image information cannot be saved.

Another advantage of the present invention is to provide a file generating device which includes identical identification information into a file name of a file of image information and a file name of a file of communication history information so that convenience of management and searching or the like of the file of the image information and the file of the communication history information can be improved by a simple process.

According to an aspect of the present invention, an image communication device includes a transmission unit, an archive processing control unit and a notification unit. The transmission unit transmits image data to a prescribed destination. The archive processing control unit sets an archive processing for transmitting the image data, which has been transmitted to the destination by the transmission unit, to a remote archive device. In case the archive processing is set, when the archive processing control unit receives a transmission instruction of the image data under a state in which the archive processing cannot be executed, the archive processing control unit suspends the transmission of the image data. When the archive processing control unit suspends the transmission of the image data, the notification unit notifies a user that the archive processing is set. The image communication device includes a setting of a FAX number and an e-mail address of the archive device. The archive processing control unit carries out a process for transmitting the image data to a prescribed archive device in accordance with the setting.

Accordingly, image data can be prevented from being transmitted under a state in which the archive processing cannot be executed although the archive processing is set.

When the archive processing is set, the transmission unit can transmit the transmitted image data and also a transmission record for a prescribed destination of the image data to the archive device. In this case, unless the image data is memorized in the image communication device, an archive processing cannot be carried out. According to the present invention, the image data can be prevented from being transmitted under such a state, and management of the image data can be carried out appropriately.

According to another aspect of the present invention, a transmission device includes a transmission unit and a saving executing unit. The transmission unit transmits image information. Before the transmission unit transmits the image information, the saving executing unit saves the image information to be transmitted by the transmission unit into a saving unit. Further, the saving unit saves the image information. After the saving of the image information has been completed, the transmission unit transmits the image information.

That is, before transmitting the image information, the transmission device outputs the image information to the saving unit (for example, an internal hard disk or a remote file server), which saves the input image information. After the saving of the image information has been completed, in other words, after a confirmation is made that the output image information has been saved, the transmission device transmits the image information. When the saving of the image information fails due to trouble such as a disconnection of the communication line with the saving unit or a lack of a saving capacity of the saving unit, the saving of the image information is not completed. Therefore, the transmission of the image information is canceled or suspended until the saving of the image information is completed.

According to another aspect of the present invention, a communication device includes a communication unit, an output unit and a connection determination unit. The communication unit transmits and/or receives image information. The output unit outputs the image information via a communication line to a remote saving unit, which saves the image information. The connection determination unit determines whether or not a connection with the communication line is established. When the connection determination unit determines that the connection is not established, the communication unit is prohibited from transmitting and/or receiving the image information.

That is, a determination is carried out as to whether or not the connection with the communication line is established. When a determination is made that the connection with the communication line is not established, the communication device does not transmit and/or receive the image information.

According to another aspect of the present invention, a file generating device generates a file of transmitted and/or received image information and a file of communication history information relating to a transmission and/or a reception result of the image information. The file generating device includes a naming unit and an output unit. The naming unit names the files by including identical identification information, which identifies the image information and the communication history information, into respective file names, excluding an extension, of the file of the image information and the file of the communication history information. The output unit outputs the files, which have been named by the naming unit, to a file memory unit. Further, the file memory unit memorizes the files.

That is, the file generating device generates a file of transmitted and/or received image information (hereinafter referred to as an “image file”), and generates a file of communication history information relating to the transmission and/or reception result of the image information (hereinafter referred to as a “communication file”). The file generating device includes identical identification information into a file name, excluding an extension, of the image file and a file name, excluding an extension, of the communication file. In this case, for example, excluding the extension, the file name of the image file and the file name of the communication file are identical. The image file and the communication file, which have been assigned with the file name including the same identification information, are respectively output to a file memory unit embedded in the file generating device or to a remote file memory unit.

For example, the file memory unit is an internal hard disk or a remote file server. The file memory unit memorizes the image file and the communication file, which have been input to the file memory unit. In this case, for example, an input image file is stored into a folder for storing an image file, and an input communication file is stored into a folder for storing a communication file. The image file and the communication file, which have been memorized in the file memory unit, are easily searched and acquired in accordance with the identification information by using a general file management software, for example.

Further, any combinations of the above-described constituent elements and conversions of the expression of the present invention between a method, a device, a system, a recording medium, a computer program or the like are also effective as a preferred embodiment of the present invention.

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a block diagram illustrating a structure of a FAX machine according to a first preferred embodiment of the present invention.

FIG. 2 is a flowchart illustrating a processing procedure of the FAX machine according to the first preferred embodiment of the present invention.

FIG. 3 is a block diagram illustrating a structure of a Multi Function Peripheral (MFP) according to a second preferred embodiment of the present invention.

FIG. 4 is a flowchart illustrating a procedure of a FAX transmission processing carried out by a Central Processing Unit (CPU) of the MFP according to the second preferred embodiment of the present invention.

FIG. 5 is a flowchart illustrating a procedure of a FAX transmission processing carried out by the CPU of the MFP according to the second preferred embodiment of the present invention.

FIG. 6 is a block diagram illustrating a structure of a file server of a file saving system including an MFP according to a third preferred embodiment of the present invention.

FIG. 7 is a flowchart illustrating a procedure of a FAX transmission processing executed by a CPU of the MFP according to the third preferred embodiment of the present invention.

FIG. 8 is a block diagram illustrating a structure of an MFP according to a fourth preferred embodiment of the present invention.

FIG. 9 is a flowchart illustrating a procedure of a transmission and reception processing carried out by a CPU of the MFP according to the fourth preferred embodiment of the present invention.

FIG. 10 is a block diagram illustrating a structure of an MFP as a file generating device according to a fifth preferred embodiment of the present invention.

FIG. 11 is a block diagram illustrating a structure of a file server of a file storage system including the MFP according to the fifth preferred embodiment of the present invention.

FIG. 12 is a flowchart illustrating a procedure of a file storage processing carried out by a CPU of the MFP according to the fifth preferred embodiment of the present invention.

FIG. 13 is a block diagram illustrating a structure of an MFP as a file generating device according to a sixth preferred embodiment of the present invention.

FIG. 14 is a flowchart illustrating a procedure of a file storage processing carried out by a CPU of the MFP according to the sixth preferred embodiment of the present invention.

### DETAILED DESCRIPTION OF PREFERRED EMBODIMENTS

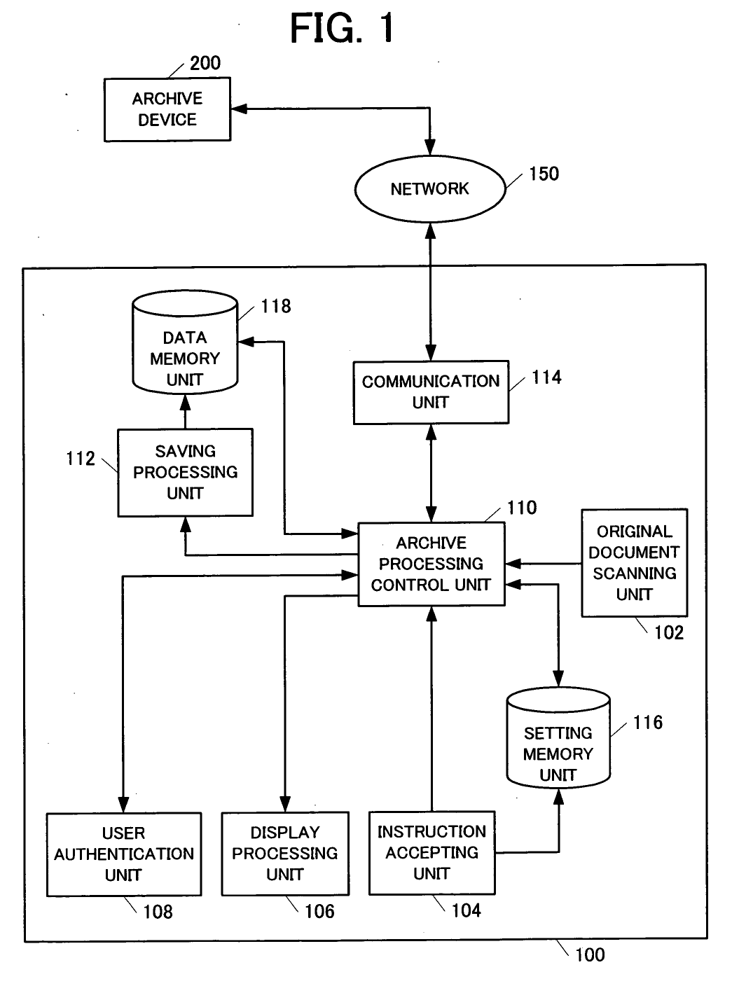

(First Preferred Embodiment) In the first preferred embodiment of the present invention, an image communication device is a FAX machine. FIG. 1 is a block diagram illustrating a structure of a FAX machine according to the first preferred embodiment of the present invention. FIG. 1 illustrates blocks representing units of function instead of units of hardware. In FIG. 1, a structure of a component unrelated to the subject matter of the present invention is not illustrated.

A FAX machine 100 includes an original document scanning unit 102, an instruction accepting unit 104, a display processing unit 106 (notification unit), a user authentication unit 108, an archive processing control unit 110, a saving processing unit 112, a communication unit 114 (transmission unit), a setting memory unit 116 and a data memory unit 118.

In the first preferred embodiment, a network 150 is a Public Switched Telephone Network (PSTN). The communication unit 114 includes a Modulator-Demodulator (MODEM) and a Network Control Unit (NCU). The communication unit 114 establishes a connection between the FAX machine 100 and the network 150 via the PSTN. In the first preferred embodiment, the FAX machine 100 carries out transmission and reception of image data with another terminal under a G3 method or a G4 method.

The original document scanning unit 102 scans an original document in a paper medium and generates image data. The instruction accepting unit 104 accepts various settings and instructions from a user. The setting memory unit 116 memorizes a setting accepted by the instruction accepting unit 104. In the first preferred embodiment, the instruction accepting unit 104 accepts a setting of an archive processing, a transmission instruction of image data, and an instruction of a transmission mode of the image data, for example. The transmission mode of the image data includes, for example, a memory transmission and a scanner transmission. Under the memory transmission, image data generated by the original document scanning unit 102 is once saved in the data memory unit 118 and then transmitted to a prescribed transmission destination. Under the scanner transmission, the image data generated by the original document scanning unit 102 is transmitted to a prescribed transmission destination without saving the image data in the FAX machine 100. The communication unit 114 transmits the image data to a prescribed destination.

The display processing unit 106 displays various pieces of information on a display unit such as a Light Emitting Diode (LED), a Cathode Ray Tube (CRT) monitor and a Liquid Crystal Display (LCD). The user authentication unit 108 authenticates a user of the FAX machine 100. The saving processing unit 112 memorizes image data transmitted thorough the memory transmission into the data memory unit 118.

The archive processing control unit 110 sets an archive processing for transmitting the image data, which has been transmitted from the communication unit 114 to the destination, to an archive device 200 located outside of the FAX machine 100. In case the archive processing is set, when a transmission instruction of the image data is made under a state in which the archive processing cannot be executed, the archive processing control unit 110 suspends the transmission of the image data. Specifically, when the original document scanning unit 102 generates image data and the instruction accepting unit 104 accepts a transmission instruction of the image data, the archive processing control unit 110 refers to the setting memory unit 116 and determines whether or not the archive processing is set. When the archive processing is set, the archive processing control unit 110 carries out the archive processing. When the archive processing is set, the archive processing control unit 110 basically memorizes the image data, which has been generated by the original document scanning unit 102, into the data memory unit 118 by the saving processing unit 112. Next, the communication unit 114 transmits the image data, which is memorized in the data memory unit 118, to a prescribed transmission destination. Then, the archive processing control unit 110 acquires a transmission record of the image data. The transmission record is memorized by being associated with the image data memorized in the data memory unit 118. Next, under a prescribed timing, the communication unit 114 transmits the image data memorized in the data memory unit 118 and the transmission record to the archive device 200. When the archive processing control unit 110 suspends the transmission of the image data, the display processing unit 106 notifies the user that the archive processing is set.

Meanwhile, when the archive processing is not set, the archive processing control unit 110 transmits the image data generated by the original document scanning unit 102 to a prescribed transmission destination by the communication unit 114 without carrying out the archive processing.

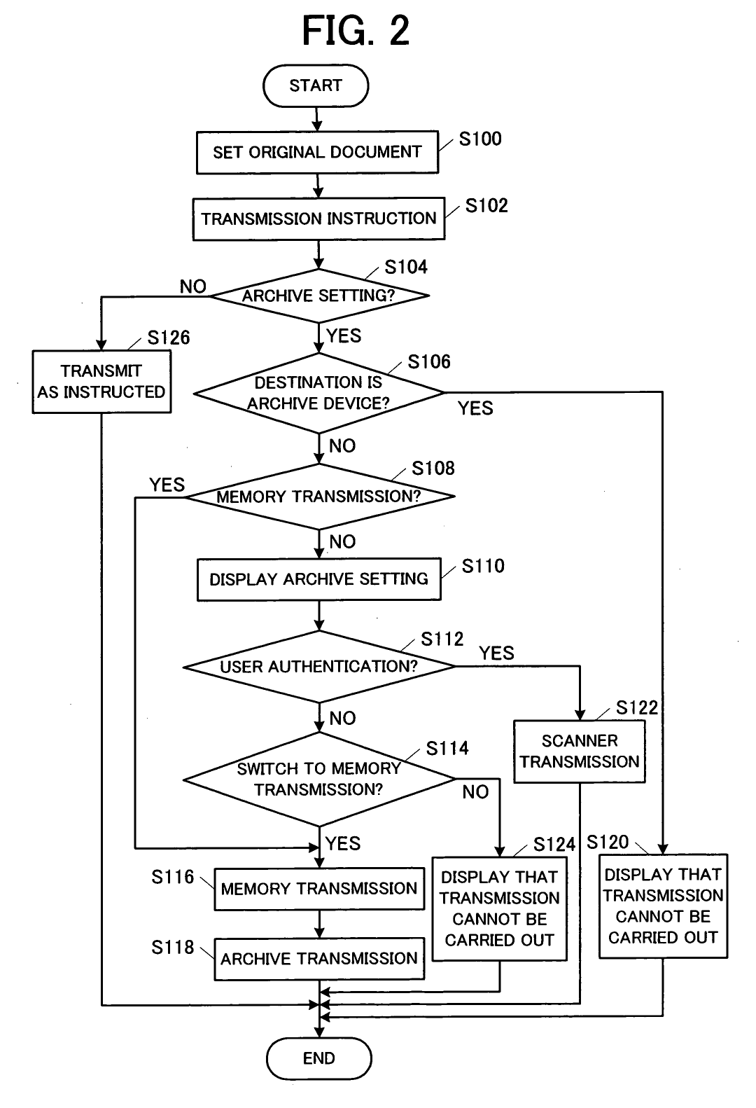

Next, with reference to FIG. 2, a description will be made of an archive processing of the FAX machine 100 according to the first preferred embodiment of the present invention. A description will be made with reference to also FIG. 1.

First, a transmission original document is set on a document table (not illustrated) (step S100), and the instruction accepting unit 104 accepts a transmission instruction (step S102). Then, the original document scanning unit 102 scans the original document and generates image data. The archive processing control unit 110 refers to the setting memory unit 116 and determines whether or not the archive processing is set (step S104). When the archive processing is not set (step S104: NO), the image data is transmitted to a prescribed transmission destination in accordance with the transmission instruction of the user (step S126). Then, the process ends.

When the archive processing is set (step S104: YES), the archive processing control unit 110 determines whether or not a transmission destination is the archive device 200 (step S106) When the transmission destination is the archive device 200 (step S106: YES), if the image data is transmitted directly, an archive processing would be executed on the image data to be transmitted to the archive device 200. The archive processing control unit 110 notifies the display processing unit 106 that the image data cannot be transmitted. The display processing unit 106 displays a message on the display unit that transmission cannot be carried out (step S120). Then, the process ends.

When the transmission destination is not an archive device (step S106: NO), the archive processing control unit 110 determines whether or not a memory transmission is instructed (step S108). When the memory transmission is instructed (step S108: YES), the archive processing control unit 110 carries out the memory transmission. That is, the archive processing control unit 110 memorizes the image data into the data memory unit 118 by the saving processing unit 112, and transmits the image data memorized in the data memory unit 118 to a prescribed transmission destination by the communication unit 114 (step S116). Subsequently, the archive processing control unit 110 acquires a communication record of the image data transmitted to the prescribed transmission destination, and memorizes the communication record into the data memory unit 118 by the saving processing unit 112. Next, under a prescribed timing, an archive processing is carried out (step S118). That is, the image data memorized in the data memory unit 118 and the communication record of the image data are transmitted to the archive device 200. Then, the process ends.

Meanwhile, when the memory transmission is not instructed and a scanner transmission is instructed at step S108 (step S108: NO), the archive processing cannot be carried out immediately. Therefore, the archive processing control unit 110 carries out a notification to the display processing unit 106. The display processing unit 106 displays on the display unit that an archive processing is set (step S110). For example, the display processing unit 106 can display on the display unit a message “Archive processing is set. When carrying out a scanner transmission, a user authentication is necessary. Do you choose to carry out the user authentication?” or “Archive processing is set. Switch to a memory transmission?” The archive processing control unit 110 can carry out a subsequent process in accordance with an instruction of the user for the displayed message. As another example, without receiving a further instruction from the user, the display processing unit 106 can display on the display unit a message “Archive processing is set. Processing will be switched to memory transmission.” Accordingly, the archive processing control unit 110 can carry out a process for automatically switching to the memory transmission.

When the user decides to carry out the user authentication at step S112 and the user authentication unit 108 carries out the user authentication (step S112: YES), the archive processing control unit 110 carries out the scanner transmission (step S122). Then, the process ends.

Meanwhile, when the user authentication is not carried out at step S112 (step S112: NO), the archive processing control unit 110 determines whether or not to switch to a memory transmission (step S114). When the user instructs to switch to the memory transmission, or when the process is switched automatically to the memory transmission (step S114: YES), the archive processing control unit 110 carries out the memory transmission (step S116). Then, the archive processing is carried out (step S118).

Meanwhile, when the user does not instruct to switch to the memory transmission at step S114, or when the process cannot be switched to the memory transmission (step S114: NO), the archive processing control unit 110 carries out a notification to the display processing unit 106 that transmission cannot be carried out. The display processing unit 106 displays on the display unit that the transmission cannot be carried out (step S124). Then, the process ends.

As described above, according to the first preferred embodiment of the present invention, the FAX machine 100 can prevent the image data from being transmitted under a state in which the archive processing cannot be executed although the archive processing is set. Accordingly, a management of the image data can be carried out appropriately. Under such a case, the transmission of the image data is suspended, and a fact that the archive processing is set is notified. Then, when a prescribed condition is satisfied, the image data is transmitted. As a result, convenience of the user is improved.

In the above-described first preferred embodiment of the present invention, the FAX machine 100 carries out the transmission and the reception of the image data with another terminal under the G3 method or the G4 method. As another example, the FAX machine 100 may be an I-FAX machine which carries out transmission and reception of image data with another terminal via a network such as the Internet.

In the above-described first preferred embodiment of the present invention, at step S110 of FIG. 2, the display unit displays a fact that the archive processing is set. As another example, the notification of a fact that the archive processing is set may be performed by voice. In the same manner, the processes of step S120 and step S124 may be carried out by a voice notification.

The processing procedure of FIG. 2 may be changed appropriately. For example, the procedure of step S112 for carrying out the user authentication may be omitted. When the memory transmission cannot be carried out, the transmission of the image data can be prohibited regardless of who the user is.

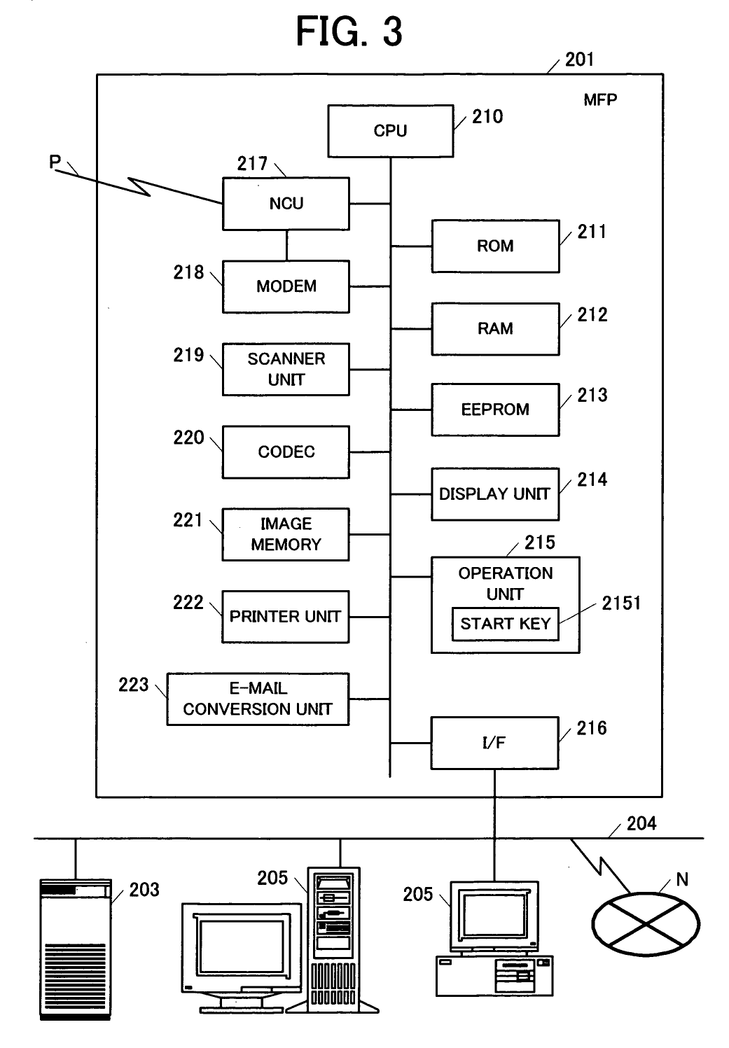

(Second Preferred Embodiment) FIG. 3 is a block diagram illustrating a structure of an MFP 201 as an image communication device according to a second preferred embodiment of the present invention. The MFP 201 is a digital MFP including a plurality of functions, such as a scanner function, a printer function, a copy function, a FAX function and an I-FAX function. In the following, a description will be made primarily of the FAX function and the I-FAX function of the MFP 201.

The MFP 201 is connected to a Local Area Network (LAN) 204 via an InterFace (I/F) 216. The MFP 201 is connected to a telephone line P via an NCU 217. The MFP 201 is connected to a file server 203, Personal Computers (PCs) 205, 205 and so forth and the Internet N via the LAN 204.

A unique FAX number is respectively assigned to the MFP 201 and a remote FAX machine (not illustrated), which is connected to the telephone line P. The MFP 201 and the remote FAX machine operate in accordance with a protocol of a communication standard of the International Telecommunication Union-Telecommunications (ITU-T) recommendation T.30. The MFP 201 and the remote FAX transmit and receive image information for FAX communication (hereinafter referred to as a “FAX image”) in accordance with a prescribed protocol.

A unique e-mail address is respectively assigned to the MFP 201 and a remote I-FAX machine (not illustrated), which is connected to the Internet N. The MFP 201 and the remote I-FAX machine transmit and receive e-mail for I-FAX communication in accordance with a prescribed protocol (for example, the Simple Mail Transfer Protocol (SMTP), the Post Office Protocol (POP)).

The e-mail for the I-FAX communication includes image information for the I-FAX communication (hereinafter referred to as an “I-FAX image”) and a header. The header includes an e-mail address of the I-FAX machine, which is a transmitter, and information such as an encoding scheme of the I-FAX image. The header and the I-FAX image both include text data.

The MFP 201 includes a CPU 210, a Read Only Memory (ROM) 211, a Random Access Memory (RAM) 212 and an Electronically Erasable and Programmable Read Only Memory (EEPROM) 213. The CPU 210 uses the RAM 212 as a working area. The CPU 210 controls each component of the MFP 201 and executes various processes in accordance with a control program and data memorized in the ROM 211 and data memorized in the EEPROM 213.

The CPU 210 memorizes e-mail received via the I/F 216 or e-mail to be transmitted via the I/F 216 into the RAM 212. The CPU 210 separates the I-FAX image and the header from the received e-mail, or generates transmission e-mail including the I-FAX image and the header. Furthermore, the CPU 210 inputs non-text image information (hereinafter referred to as a “regular image”) or the I-FAX image into an e-mail conversion unit 223. The regular image and the I-FAX image are converted reciprocally under a prescribed encoding scheme (for example, Multipurpose Internet Mail Extensions (MIME) base 64). In the second preferred embodiment, the regular image is in a Tagged Image File Format (tiff).

A display unit 214 of the MFP 201 includes an LCD panel. An operation unit 215 includes various function keys (for example, a start key 2151). The function keys are a hard key or a soft key. The soft key is arranged on a touch screen arranged on the display unit 214 by the CPU 210. The CPU 210 controls the display unit 214. For example, the display unit 214 displays an operational status of the MFP 201, an input instruction for a user, and an image indicating a position of the soft key arranged on the operation unit 215. The user of the MFP 201 operates various function keys of the operation unit 215 while looking at the display unit 214.

The user inputs destination information into the MFP 201 by using the operation unit 215. For example, the destination information is a FAX number or an e-mail address used by the CPU 210 for a determination at step S215 in a FAX transmission processing described hereinafter. The destination information is destination information of a transmission destination or a transmitter, which is required to save the regular image in the file server 203, among transmission destinations or transmitters of the FAX image (or e-mail for the I-FAX communication). The input destination information is memorized in the EEPROM 213. Further, the destination information may be memorized previously in the ROM 211 or may be memorized in the RAM 212. Alternatively, the MFP 201 may memorize destination information of a transmission destination or a transmitter, which is not required to save the regular image in the file server 203. Furthermore, a regular image relating to all of transmission destinations or transmitters may be saved in the file server 203. Alternatively, the user may select whether or not to save the regular image each time.

A scanner unit 219 of the MFP 201 optically scans an image of an original document set at an image scanning position of the scanning unit 219 and forms a regular image. The MFP 201 includes an image memory 221. The image memory 221 includes a Dynamic Random Access Memory (DRAM) and memorizes the regular image and/or a FAX image. The MFP 201 also includes a Coder-Decoder (CODEC) 220, an NCU 217 and a MODEM 218. The CODEC 220 carries out an encoding of the regular image and a decoding of the FAX image under a prescribed encoding scheme. The NCU 217 controls the telephone line P. The MODEM 218 carries out a transmission and a reception of the FAX image with a FAX machine (not illustrated) via the telephone line P. A printer unit 222 of the MFP 201 includes an electro-photographic printer device and a paper feed device which feeds paper to the printer device. The printer unit 222 forms an image on printing paper in accordance with the regular image memorized in the image memory 221.

Each PC 205 communicates with the file server 203 via the LAN 204, and browses and acquires the regular image saved in the file server 203.

In the following, a description will be made of FAX communication. A transmission and reception processing relating to I-FAX communication is substantially the same as the FAX communication.

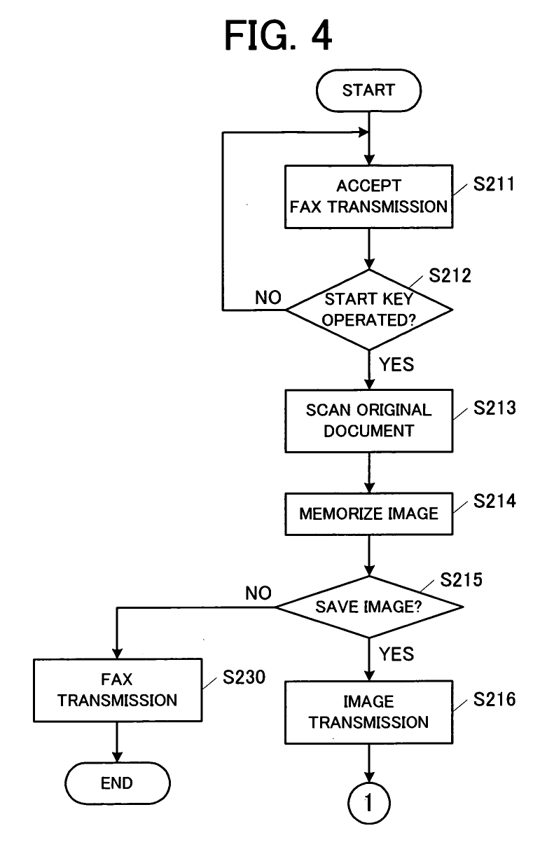

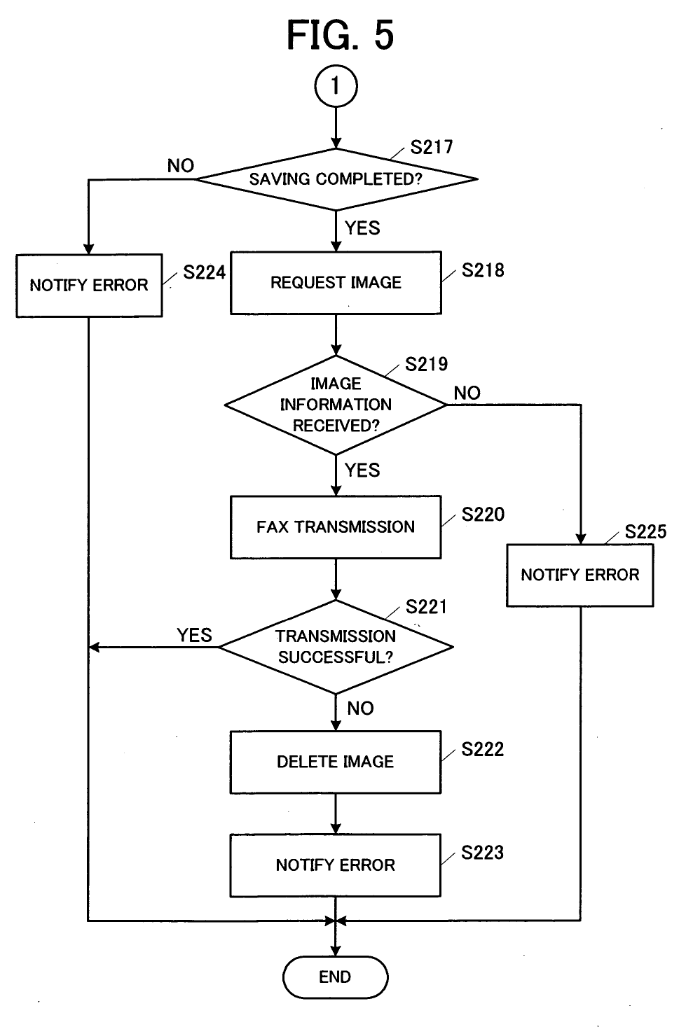

FIG. 4 and FIG. 5 are flowcharts illustrating a procedure of a FAX transmission processing carried out by the CPU 210. The FAX transmission processing is carried out, for example, when a prescribed function key of the operation unit 215 has been operated and the MFP 201 proceeds onto a FAX transmission mode.

The CPU 210 accepts FAX transmission (step S211). Specifically, the CPU 210 accepts an input of a FAX number of a transmission destination of a FAX image, a resolution of the FAX image and the like via the operation unit 215.

The user of the MFP 201 sets an original document on the MFP 201. The user inputs the FAX number and the resolution or the like by operating the operation unit 215. Then, the user operates the start key 2151.

The CPU 210 determines whether or not the start key 2151 has been operated (step S212). When the start key 2151 has not been operated (step S212: NO), the CPU 210 returns the process to step S211 and continues to accept FAX transmission.

After the FAX number has been input, when the start key 2151 is operated (step S212: YES), the CPU 210 scans the original document set on the MFP 201 by using the scanner unit 219 and forms a regular image (step S213). The CPU 210 memorizes the regular image as the image information into the image memory 221 (step S214).

The CPU 210 determines whether or not to save the regular image memorized in the image memory 221, that is, the regular image corresponding to a transmission FAX image, into the file server 203 (step S215). At step S215, the CPU 210 determines whether or not destination information of the transmission destination, to which the FAX image has been transmitted, or destination information of the transmitter, which has transmitted the FAX image, is memorized in the EEPROM 213. When the destination information is memorized, the CPU 210 determines to save the regular image in the file server 203.

When the CPU 210 determines to save the regular image in the file server 203 (step S215: YES), the CPU 210 retrieves the regular image memorized in the image memory 221 and transmits the regular image to the file server 203 via the LAN 204 (step S216) The file server 203, which has received the regular image as a result of the process of step S216 by the CPU 210, saves the received regular image. When the saving has been completed, the file server 203 transmits to the MFP 201, saving completion information indicating that the saving has been completed.

After the process of step S216 has been completed, the CPU 210 determines whether or not the saving completion information has been received within a prescribed period of time (step S217). When the saving completion information has been received (step S217: YES), since the saving of the image information has been completed in the file server 203, in other words, since the image information has been saved reliably in the file server 203, the CPU 210 transmits image request information to the file server 203 to request the saved image information (image information transmitted at step S216) (step S218). The file server 203, which has received the image request information as a result of the process of step S218 by the CPU 210, retrieves image information corresponding to the received image request information and transmits the retrieved image information to the MFP 201.

Next, the CPU 210 determines whether or not the image information has been received within a prescribed period of time (step S219). When the image information has been received (step S219: YES), the CPU 210 inputs the received regular image into the CODEC 220 to convert the regular image into a FAX image. Then, the CPU 210 controls the NCU 217 and the MODEM 218 and carries out FAX transmission of the converted FAX image via the telephone line P by using the FAX number accepted at step S211 (step S220).

After the process of step S220 has been completed, the CPU 210 determines whether the FAX transmission has resulted in a success or has failed (step S221). When the FAX transmission has resulted in a success (step S221: YES), the FAX transmission processing ends. Meanwhile, when the FAX transmission has failed (step S221: NO), the CPU 210 communicates with the file server 203 and transmits deletion request information to the file server 203 (step S222). Further, the deletion request information requests a deletion of the image information transmitted at step S216. The file server 203, which has received the deletion request information as a result of the process of step S222 by the CPU 210, deletes the saved regular image.

After the process of step S222 has been completed, the CPU 210 carries out an error notification to the user (step S223). Specifically, the CPU 210 displays a message on the display unit 214 indicating that the regular image will not be saved due to the failure of the FAX transmission. After the process of step S223 has been completed, the CPU 210 ends the FAX transmission processing.

When the CPU 210 does not receive the saving completion information from the file server 203 within a prescribed period of time (step S217: NO), the saving of the image information has not been completed in the file server 203. In other words, the saving of the image information has resulted in a failure. Therefore, the CPU 210 carries out an error notification to the user (step S224). Specifically, the CPU 210 displays a message on the display unit 214 indicating that the FAX transmission cannot be executed in the MFP 201 since the image information failed to be saved. After the process of step S224 has been completed, the CPU 210 ends the FAX transmission processing. Further, a reason why the image information cannot be saved (for example, a communication trouble of the LAN 204, a lack of a memory capacity of the file server 203) may also be notified.

When the image information has not been received from the file server 203 within a prescribed period of time (step S219: NO), a confirmation cannot be made again as to whether or not the image information is saved in the file server 203. Therefore, the CPU 210 carries out an error notification to the user (step S225). Specifically, the CPU 210 displays a message on the display unit 214 indicating a fact that the FAX transmission cannot be executed by the MFP 201 since it is unclear as to whether or not the image information has been saved. After the process of step S225 has been completed, the CPU 210 ends the FAX transmission processing.

When the CPU 210 determined not to save the regular image in the file server 203 (step S215: NO), the CPU 210 retrieves the regular image memorized in the image memory 221. The CPU 210 inputs the regular image into the CODEC 220 to convert the regular image into a FAX image. The CPU 210 controls the NCU 217 and the MODEM 218 and carries out a FAX transmission of the converted FAX image via the telephone line P by using the FAX number accepted at step S211 (step S230). After the process of step S230 has been completed, the CPU 210 ends the FAX transmission processing.

Further, the CPU 210 may compare the image information received at step S219 with the image information, which has been memorized into the image memory 221 at step S214. Then, the CPU 210 may determine whether or not to execute the FAX transmission in accordance with a comparison result.

The file server 203 in the above-described FAX transmission processing functions as a saving unit which saves the image information. The CPU 210 at step S220 functions as a transmission unit which transmits the image information. The CPU 210 at steps S216 and S217 functions as a saving executing unit which saves the image information to be transmitted by the transmission unit into the saving unit before the image information is transmitted by the transmission unit. In case of YES at step S217, the CPU 210 executes the process of step S220. Accordingly, after the saving of the image information has been completed, the transmission unit transmits the image information.

The CPU 210 at steps S218 and S219 functions as an acquiring unit which acquires image information saved in the saving unit after the image information has been saved into the saving unit by the saving executing unit. In case of YES at step S219, the CPU 210 executes the process of step S220. Accordingly, the transmission unit transmits the image information acquired by the acquiring unit.

The CPU 210 at step S221 functions as a determination unit which determines whether or not the transmission of the transmission unit has been completed. The CPU 210 at step S222 functions as a deletion executing unit which deletes the image information saved in the saving unit when the determination unit determines that the transmission has not been completed.

The above-described MFP 201 saves the regular image corresponding to the transmission FAX image into the file server 203 before transmitting the FAX image. After the completion of the saving has been confirmed, the MFP 201 transmits the FAX image, which has been formed by encoding the regular image saved in the file server 203. Therefore, the regular image corresponding to the transmitted FAX image can be saved reliably in the file server 203. When the transmission of the regular image has not been completed, the MFP 201 deletes the image information saved in the file server 203. Therefore, only the regular image corresponding to the transmitted FAX image can be saved reliably in the file server 203.

The user accesses the file server 203 by using the PC 205, for example. The user can easily browse, acquire or manage the regular image memorized in the file server 203. Since the regular image is in a tiff format, the regular image can be used easily.

Instead of saving the regular image corresponding to the transmitted FAX image in the file server 203, the regular image may be memorized in a hard disk embedded in the MFP 201. In this case, an increase of a traffic of the LAN 204 can be prevented. In case of saving the regular image in the file server 203 as in the second preferred embodiment of the present invention, the MFP 201 is not required to include a hard disk with a large memory capacity for memorizing a large volume of regular image. Therefore, a production cost of the MFP 201 can be reduced. Furthermore, the MFP 201 can be decreased in size. The regular image to be saved in the file server 203 may be compressed and then saved.

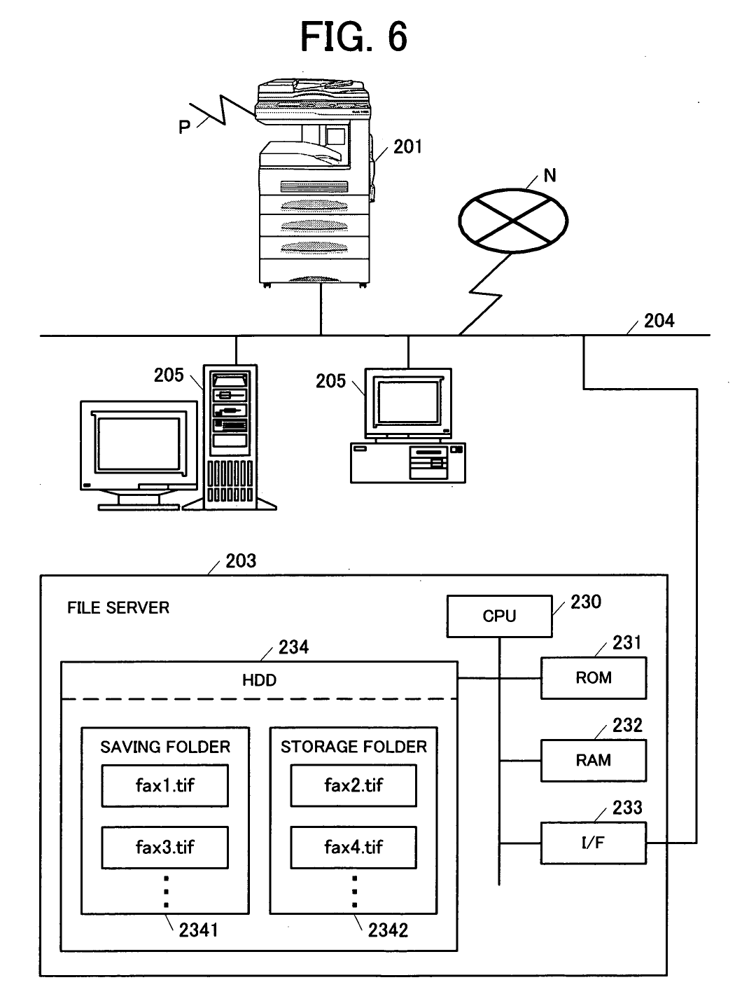

(Third Preferred Embodiment) FIG. 6 is a block diagram illustrating a structure of a file server 203 of a file saving system including an MFP 201 as an image communication device according to a third preferred embodiment of the present invention. The file server 203 includes a CPU 230, a ROM 231, a RAM 232, an I/F 233 and a Hard Disk Drive (HDD) 234. The file server 203 is connected to a LAN 204 via the I/F 233. The file server 203 is also connected to the MFP 201 and the PCs 205 and 205 via the LAN 204. The CPU 230 uses the RAM 232 as a working area. The CPU 230 control each component of the file server 203 and executes various processes in accordance with a control program and data memorized in the ROM 231 and/or the HDD 234.

The HDD 234 previously includes a saving folder 2341 and a storage folder 2342. The saving folder 2341 saves a regular image corresponding to a FAX image which a FAX transmission from the MFP 201 to a remote FAX machine has resulted in a success. The storage folder 2342 stores a regular image corresponding to a FAX image which a FAX transmission has resulted in a failure.

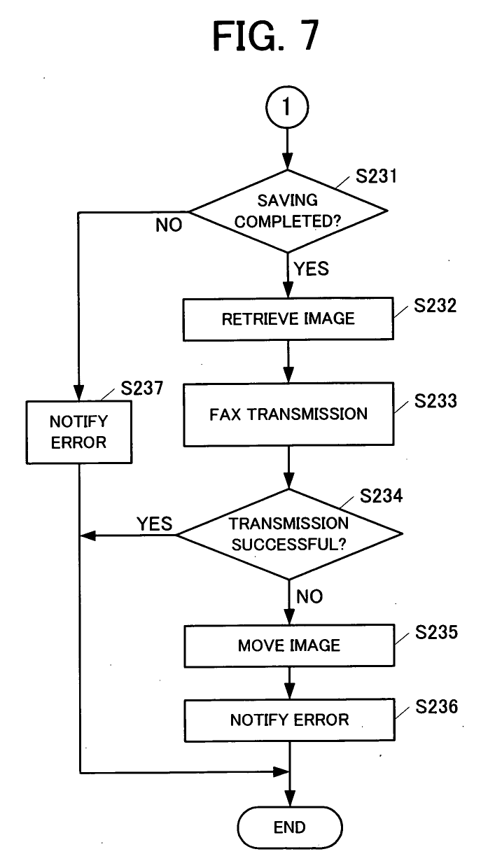

FIG. 7 is a flowchart illustrating a procedure of a FAX transmission processing executed by the CPU 210. In the FAX transmission processing, processes corresponding to the processes of steps S211 through S216 and S230 of FIG. 4 are executed. Thus, these processes are not illustrated in FIG. 7.

In a process corresponding to the process of step S216, the CPU 210 retrieves the regular image memorized in the image memory 221, and transmits the regular image via the LAN 204 to the file server 203. The file server 203, which has received the regular image as a result of the process by the CPU 210, saves the received regular image in the saving folder 2341. When the saving has been completed, the file server 203 transmits saving completion information indicating that the saving has been completed to the MFP 201.

After the above process has been completed, the CPU 210 determines whether or not the saving completion information has been received with a prescribed period of time (step S231). When the saving completion information has been received (step S231: YES), the saving of the image information has completed in the file server 203. In other words, the image information has been saved reliably. Therefore, the CPU 210 retrieves the regular image from the image memory 221 (step S232). The CPU 210 inputs the fetched regular image into the CODEC 220, and the regular image is converted into a FAX image. The CPU 210 controls the NCU 217 and the MODEM 218 and carries out a FAX transmission of the converted FAX image via the telephone line P by using the FAX number accepted at step S211 (step S233).

After the process of step S233 has been completed, the CPU 210 determines whether or not the FAX transmission has resulted in a success or a failure (step S234). When the FAX transmission has resulted in a success (step S234: YES), the FAX transmission processing ends. Meanwhile, when the FAX transmission has resulted in a failure (step S234: NO), the CPU 210 communicates with the file server 203 and transmits a movement request information to the file server 203 for moving the image information transmitted at step S216 (step S235). The file server 203, which has received the movement request information as a result of the process of step S235 by the CPU 210, moves the regular image saved in the saving folder 2341 to the storage folder 2342.

After the process of step S235 has been completed, the CPU 210 carries out an error notification to the user (step S236). Specifically, the CPU 210 displays a message on the display unit 214 indicating that the saved regular image has been stored into adifferent folder due to the failure of the FAX transmission. After the process of step S236 has been completed, the CPU 210 ends the FAX transmission processing.

A process of step S237 is the same as the process of step S224 illustrated in FIG. 5. Therefore, a description of the process of step S237 will be omitted. Like reference numerals are applied to parts corresponding to the second preferred embodiment, and a description will be omitted.

The saving folder 2341 of the file server 203 in the above-described FAX transmission processing functions as a remote saving unit which saves the image information. The CPU 210 at step S233 functions as a transmission unit which transmits the image information. The CPU 210 at steps S216 and S231 functions as a saving executing unit which saves the image information to be transmitted by the transmission unit into the saving unit before the image information is transmitted by the transmission unit. In case of YES at step S231, the CPU 210 executes the process of step S233. Accordingly, after the saving of the image information has been completed, the transmission unit transmits the image information.

The image memory 221 of the MFP 201 functions as a memory unit which memorizes image information to be transmitted by the transmission unit. The CPU 210 retrieves the regular image from the image memory 221 at step S232. Accordingly, the transmission unit transmits the image information memorized in the memory unit.

The storage folder 2342 of the file server 203 differs from the saving unit and functions as a storage unit which stores the image information. The CPU 210 at step S234 functions as a determination unit which determines whether or not the transmission unit has completed the transmission. The CPU 210 at step S235 functions as a movement executing unit which moves the image information saved in the saving unit to the storage unit when the determination unit determines that the transmission has not been completed.

The above-described MFP 201 saves the regular image corresponding to the transmission FAX image into the saving holder 2341 before transmitting the FAX image. After confirming that the saving of the regular image has been completed, the MFP 201 transmits the FAX image, which has been encoded from the regular image memorized in the image memory 221. Therefore, the regular image corresponding to the transmitted FAX image can be saved reliably in the saving holder 2341. In addition, the MFP 201 is not required to communicate with the file server 203 for transmitting the FAX image. As a result, an increase of a traffic of the LAN 204 can be suppressed.

Furthermore, when the transmission of the image information has not been completed, the regular image saved in the saving holder 2341 is moved to the storage folder 2342. Therefore, the regular image corresponding to the transmitted FAX image can be saved reliably in the file server 203. In addition, the regular image corresponding to the FAX image, which has not been transmitted, can also be left.

The user accesses the file server 203 by using the PC 205, for example. The user can easily browse or acquire the regular image memorized in the saving holder 2341 and/or the storage folder 2342. Since the regular image is in a tiff format, the regular image can be used easily.

Further, instead of storing the regular image corresponding to the untransmitted FAX image in the storage folder 2342 of the file server 203, the regular image may be memorized in an internal hard disk of the MFP 201. In this case, an increase in the traffic of the LAN 204 can be prevented. However, in case of storing the regular image in the storage folder 2342 of the file server 203 as in the third preferred embodiment of the present invention, the MFP 201 is not required to include a hard disk with a large memory capacity for memorizing a large volume of regular image. Therefore, a production cost of the MFP 201 can be reduced, and the MFP 201 can be decreased in size.

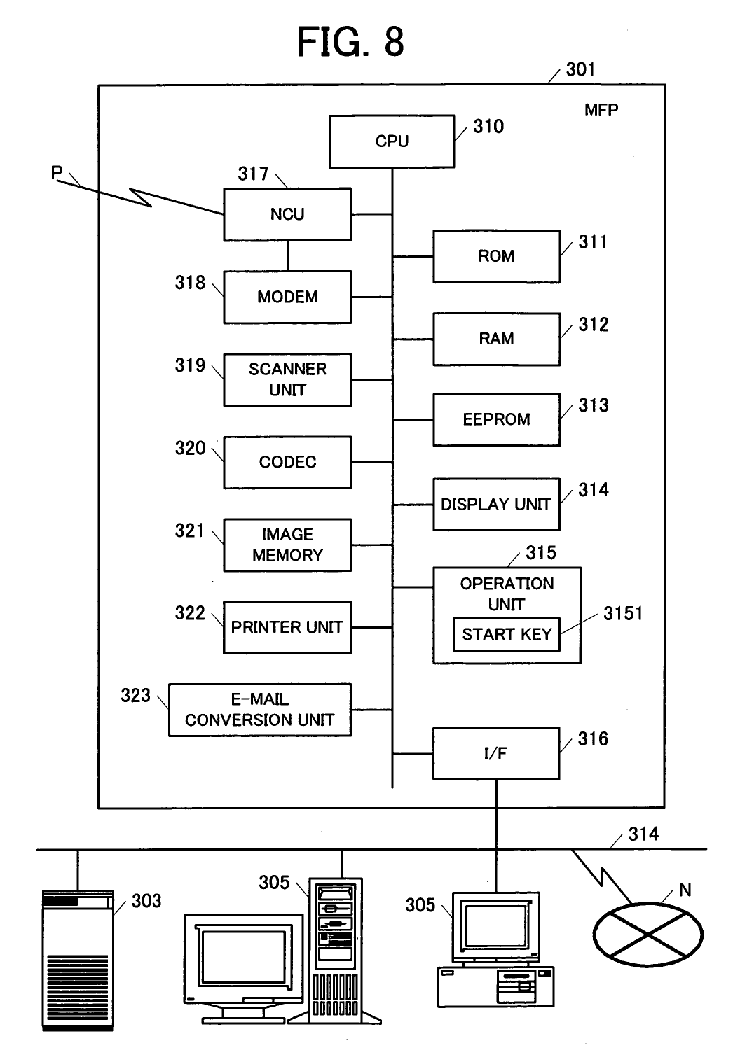

(Fourth Preferred Embodiment) FIG. 8 is a block diagram illustrating a structure of an MFP 301 as an image communication device according to a fourth preferred embodiment of the present invention.

The MFP 301 is a digital MFP including a plurality of functions such as a scanner function, a printer function, a copy function, a FAX function and an I-FAX function. The MFP 301 includes a communication unit for transmitting and/or receiving image information, and an output unit for outputting the image information via a communication line to a remote saving unit which saves the image information. In the following, a description will be made primarily of the FAX function and the I-FAX function of the MFP 301.

The MFP 301 is connected to a LAN 304 via an I/F 316. The MFP 301 is connected to a telephone line P via an NCU 317. Furthermore, the MFP 301 is connected to a file server 303, PCs 305, 305 and so forth and the Internet N via the LAN 304.

A unique FAX number is respectively assigned to each of the MFP 301 and a remote FAX machine (not illustrated), which is connected to the telephone line P. The MFP 301 and the remote FAX machine are configured to operate in accordance with the protocol of the communication standard of the ITU-T Recommendation T.30 and to transmit and receive image information for FAX communication (hereinafter a “FAX image”) in accordance with a prescribed protocol.

A unique e-mail address is respectively assigned to the MFP 301 and a remote I-FAX machine (not illustrated), which is connected to the Internet N. The MFP 301 and the remote I-FAX machine transmit and receive e-mail for I-FAX communication in accordance with a prescribed protocol (for example, the SMTP).

The e-mail for the I-FAX communication includes image information for the I-FAX communication (hereinafter an “I-FAX image”) and a header. The header includes an e-mail address of the I-FAX machine, which is a transmitter, and information such as an encoding scheme of the I-FAX image. The header and the I-FAX image both include text data.

The MFP 301 includes a CPU 310, a ROM 311, a RAM 312 and an EEPROM 313. The CPU 310 uses the RAM 312 as a working area. The CPU 310 controls each component of the MFP 301 and executes various processes in accordance with a control program and data memorized in the ROM 311 and data memorized in the EEPROM 313. A publicly known image conversion software is installed in the ROM 311. The CPU 310 converts a FAX image into image information in a tiff format (hereinafter a “tiff image”) in accordance with the image conversion software.

The CPU 310 memorizes e-mail received via the I/F 316 or e-mail to be transmitted via the I/F 316 into the RAM 312. The CPU 310 separates an I-FAX image and a header from the received e-mail, or generates transmission e-mail including the I-FAX image and the header. The CPU 310 inputs a tiff image or an I-FAX image into the e-mail conversion unit 323 and reciprocally converts the tiff image and the I-FAX image under a prescribed encoding scheme (for example, base 64 of the MIME).

A display unit 314 of the MFP 301 includes an LCD panel. An operation unit 315 includes various function keys (for example, a start key 3151). The function keys are a hard key and a soft key. The soft key is arranged on a touch screen arranged on the display unit 314 by the CPU 310. The CPU 310 controls the display unit 314. For example, the display unit 314 displays an operational status of the MFP 301, an input instruction for the user, and an image indicating a position of the soft key arranged on the operation unit 315. The user of the MFP 301 operates various function keys of the operation unit 315 while looking at the display unit 314.

A scanner unit 319 of the MFP 301 optically scans an image of an original document set at an image scanning position of the scanner unit 319 and forms a raster image. The MFP 301 also includes an image memory 321, which includes a DRAM and memorizes a FAX image. The MFP 301 also includes a CODEC 320, an NCU 317 and a MODEM 318. The CODEC 320 encodes a raster image and converts into a FAX image under a prescribed encoding scheme. The CODEC 320 decodes a FAX image and converts into a raster image under a prescribed encoding scheme. The NCU 317 controls the telephone line P. The MODEM 318 transmits and receives a FAX image to and from a FAX machine (not illustrated) via the telephone line P. A printer unit 322 of the MFP 301 includes an electrophotographic printer device and a paper feed device which feeds paper to the printer device. The printer unit 322 forms an image on printing paper in accordance with the raster image.

When a LAN cable is inserted in a slot of the I/F 316, an electric current flows to the I/F 316. The CPU 310 detects the electric current flowing to the I/F 316 to determine whether or not the LAN cable is connected to the I/F 316, in other words, whether or not the MFP 301 is connected to the LAN 304.

Each PC 305 communications with the file server 303 via the LAN 304, and browses and acquires a tiff image saved in the file server 303.

In the following, a description will be made of FAX communication. A transmission and reception processing relating to the I-FAX communication is substantially the same as the FAX communication.

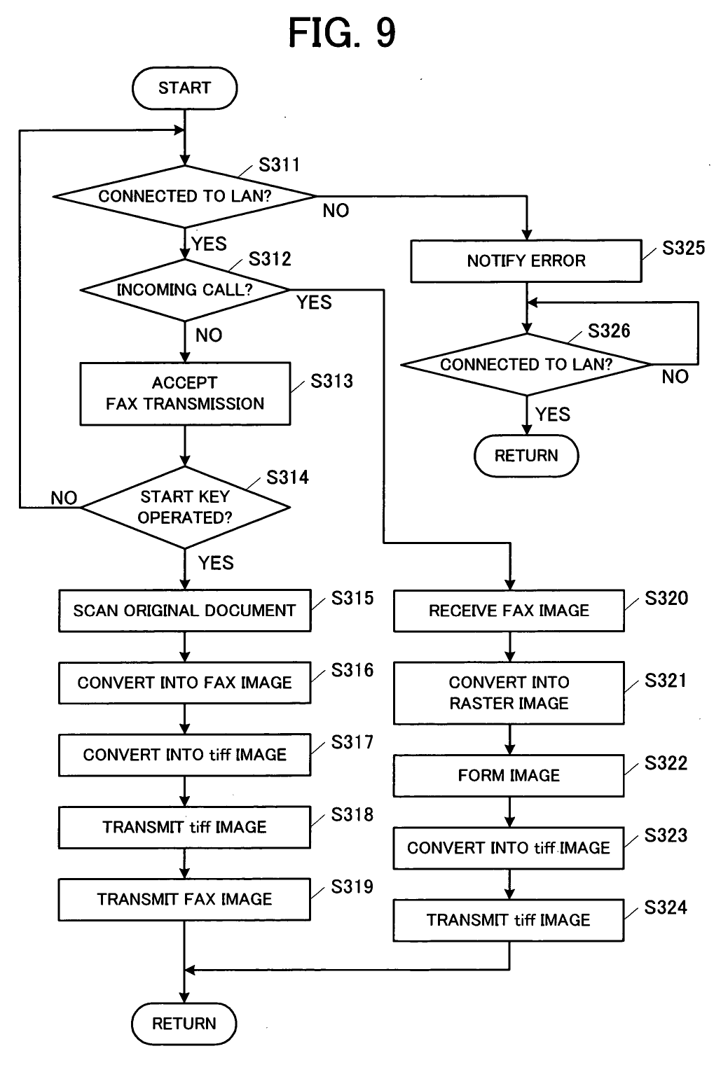

FIG. 9 is a flowchart illustrating a procedure of a transmission and reception processing executed by the CPU 310. The CPU 310 determines whether or not the I/F316 is connected to the LAN 304 (step S311). When the I/F 316 is connected to the LAN 304 (step S311: YES), the CPU 310 determines whether or not an incoming call has been received from a remote FAX machine by using a FAX number of the MFP 301 (step S312). When an incoming call has not been received (step S312: NO), the CPU 310 accepts a FAX transmission (step S313). At step S313, specifically, the CPU 310 accepts an input of a FAX number of a transmission destination of the FAX image, a resolution of the FAX image or the like via the operation unit 315.

The user of the MFP 301 sets an original document at the MFP 301. Then, the user inputs the FAX number and the resolution or the like by operating the operation unit 315 and operates the start key 3151.

The CPU 310 determines whether or not the start key 3151 has been operated (step S314). When the start key 3151 has not been operated (step S314: NO), the CPU 310 returns the process to step S311. Until a connection between the I/F 316 and the LAN 304 is disconnected (in case of NO at step S311 described hereinafter), or until receiving an incoming call from a remote FAX machine (in case of YES at step S312 described hereinafter), the processes of steps S311 through S314 are repeated.

After the FAX number has been input, when the start key 3151 is operated (step S314: YES), the CPU 310 scans the original document set on the MFP 301 by the scanner unit 319 and forms a raster image (step S315). The CPU 310 inputs the raster image into the CODEC 320, and the raster image is converted into a FAX image (step S316). The converted FAX image is memorized into the image memory 312. Next, the CPU 310 converts the FAX image memorized in the image memory 313 into a tiff image (step S317). The CPU 310 transmits the converted tiff image via the LAN 304 to the file server 303 (step S318). The file server 303, which received the tiff image as a result of the process of step S318 performed by the CPU 310, saves the received tiff image.

Lastly, the CPU 310 controls the NCU 317 and the MODEM 318 and carries out FAX transmission of the FAX image memorized in the image memory 321 via the telephone line P by using the FAX number accepted at step S313 (step S319). After the process of step S319 has been completed, the CPU 310 returns the process to step S311.

When receiving an incoming call from a remote FAX machine (step S312: YES), the CPU 310 controls the NCU 317 and the MODEM 318 and receives a FAX image, which has been transmitted from the FAX machine via the telephone line P (step S320). The CPU 310 memorizes the received FAX image into the image memory 321. Next, the CPU 310 inputs the FAX image, which is memorized in the image memory 321, to the CODEC 320 to convert into a raster image (step S321). The CPU 310 inputs the converted raster image into the printer unit 322. An image based on the raster image is formed on printing paper and is output (step S322). Lastly, the CPU 310 converts the FAX image memorized in the image memory 321 into a tiff image (step S323). The CPU 310 transmits the converted tiff image via the LAN 304 to the file server 303 (step S324). Then, the process returns to step S311. The file server 303, which has received the tiff image as a result of the process of step S324 by the CPU 310, saves the received tiff image.

When the I/F 316 is not connected to the LAN 304 (step S311: NO), the CPU 310 carries out an error notification to the user (step S325). Specifically, the CPU 310 displays a message on the display unit 314 indicating that the MFP 301 is not connected to the LAN 304 and thus a FAX transmission and a FAX reception cannot be executed.

Furthermore, the CPU 310 determines whether or not the I/F 316 is connected to the LAN 304 (step S326). When the I/F 316 is connected to the LAN 304 (step S326: YES), the CPU 310 deletes the error notification displayed on the display unit 314 and returns the process to step S311. Meanwhile, when the I/F 316 is yet to be connected to the LAN 304 (step S326: NO), until the I/F 316 is connected to the LAN 304, the CPU 310 goes on standby while continuing the error notification on the display unit 314. The processes of steps S312 through S324 are not executed. Therefore, until the I/F 316 is connected to the LAN 304, the process for scanning the original document for FAX transmission and the process for memorizing (accumulating) in the image memory 321 are not executed.

The file server 303 in the above-described transmission and reception processing functions as a remote saving unit which saves image information. The CPU 310 at steps S319 and S320 functions as a communication unit which transmits and/or receives the image information. The CPU 310 at steps S318 and S324 functions as an output unit which outputs the image information via a communication line to the saving unit. The CPU 310 at steps S311 and S326 functions as a connection determination unit which determines whether or not the MFP 301 is connected to the communication line. When the connection determination unit determines that a connection is not established (in case of NO at step S311 and NO at step S326), the processes of steps S312 through S324 are not executed. Accordingly, the communication unit is prohibited from transmitting and/or receiving the image information.

In case of YES at step S311, the process of step S318 is executed before the CPU 310 executes the process of step S319. Accordingly, when the connection determination unit determines that a connection is established, before the communication unit transmits the image information, the communication unit outputs the transmission image information to the saving unit.

The CPU 310 and the scanner unit 319 at step S315 function as a scanner unit which scans an original document and obtains image information. In case of NO at step S311, the process of step S315 is not executed by the CPU 310. Accordingly, the transmission of the image information by the communication unit is prohibited. In such a case, the scanning of the original document by the scanner unit is prohibited.

When the MFP 301 is not connected to the LAN 304, the MFP 301 does not execute the FAX transmission and the FAX reception. When the MFP 301 is connected to the LAN 304, the MFP 301 executes the FAX reception and then saves the tiff image in the file server 303. Alternatively, the MFP 301 saves the tiff image in the file server 303 and then executes the FAX transmission. Therefore, the tiff image corresponding to the transmitted and/or received FAX image can be saved reliably in the file server 303.

When the FAX transmission and the FAX reception are not executed since the MFP 301 is not connected to the LAN 304, an error notification is carried out to the user. As a result, convenience of the user can be improved. Since the original document is not accumulated in the above-described case, it is possible to prevent the user from performing wasteful work.

The user accesses the file server 303 by using the PC 305, for example. The user can easily browse, acquire, use or manage the tiff image memorized in the file server 303.

Further, the file server 303 may save only one of the tiff image relating to the FAX transmission and the tiff image relating to the FAX reception instead of saving both. The MFP 301 may be connected to the LAN 304 wirelessly instead of by a wire connection. Furthermore, the tiff image to be saved in the file server 303 may be saved after being compressed.

By using the destination information of the transmission destination of the FAX image or the destination information of the transmitter of the FAX image, a determination may be carried out as to whether or not to save the tiff image in the file server 303. When not saving the tiff image, a FAX transmission and/or a FAX reception may be carried out even when the connection with the LAN 304 is disconnected. Furthermore, the MFP 301 may include two pairs of an NCU and a MODEM for a first communication line connected to a remote FAX machine and a second communication line connected to a file server. The MFP 301 may carry out a transmission and a reception of a FAX image with the FAX machine through the first communication line. The MFP 301 may transmit a FAX image to the file server through the second communication line and save the transmitted FAX image into the file server.

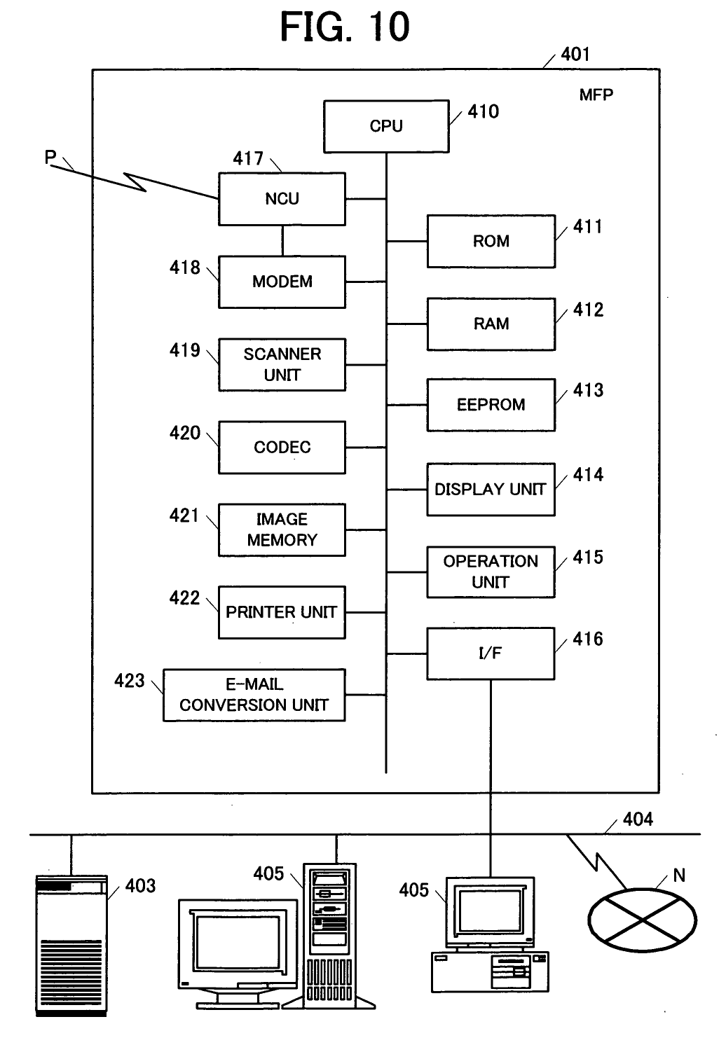

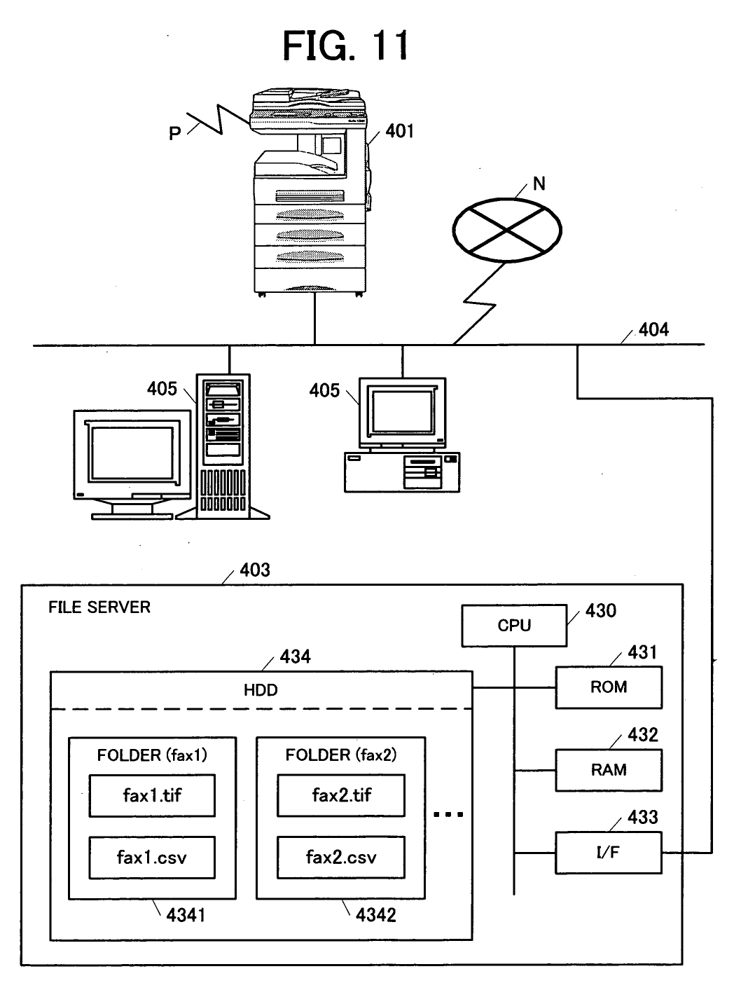

(Fifth Preferred Embodiment) FIG. 10 is a block diagram illustrating a structure of an MFP 401, which is an image communication device as a file generating device according to a fifth preferred embodiment of the present invention. FIG. 11 is a block diagram illustrating a structure of a file server 403 of a file storage system including the MFP 401.

The MFP 401 is a digital MFP including a plurality of functions such as a scanner function, a printer function, a copy function, a FAX function and an I-FAX function. The MFP 401 generates an image file and a communication file. The image file is a file of transmitted and/or received image information. The communication file is a file of communication history information relating to a date and time of transmission and/or reception of the image information, destination information of another party of the transmission and/or the reception, a number of transmitted and/or received sheets, a time required for transmission and/or reception, and a transmission and/or reception result such as a success or a failure of the transmission and/or the reception. The communication history information in the fifth preferred embodiment is in a Comma Separated Value (CSV) format. In the following, a description will be made primarily of the FAX function and the I-FAX function of the MFP 401.

The MFP 401 is connected to a LAN 404 via an I/F 416. The MFP 401 is connected to the telephone line P via an NCU 417. The MFP 401 is also connected to a file server 403 via the LAN 404. The MFP 401 is also connected to PCs 405 and 405 and so forth, in which a publicly known file management software is respectively installed, via the LAN 404. The MFP 401 is also connected to the Internet N via the LAN 404.

A unique FAX number is respectively assigned to the MFP 401 and a remote FAX machine (not illustrated), which is connected to the telephone line P. The MFP 401 and the remote FAX machine operate in accordance with a protocol of the communication standard of the ITU-T Recommendation T.30. The MFP 401 and the remote FAX machine are configured to transmit and receive image information for FAX communication (hereinafter a “FAX image”) in accordance with a prescribed protocol.

A unique e-mail address is respectively assigned to the MFP 401 and a remote FAX machine (not illustrated), which is connected to the Internet N. The MFP 401 and the remote I-FAX machine transmit and receive e-mail for I-FAX communication in accordance with a prescribed protocol (for example, the SMTP).

The e-mail for the I-FAX communication includes image information for the I-FAX communication (hereinafter an “I-FAX image”) and a header. The header includes an e-mail address of an I-FAX machine, which is a transmitter, and information such as an encoding scheme of the I-FAX image. The header and the I-FAX image include text data.

The MFP 401 includes a CPU 410, a ROM 411, a RAM 412 and an EEPROM 413. The CPU 410 uses the RAM 412 as a working area. The CPU 410 controls each component of the MFP 401 and executes various processes in accordance with a control program and data stored in the ROM 411 and data stored in the EEPROM 413.

The CPU 410 memorizes e-mail received via an I/F 416 or e-mail to be transmitted via the I/F 416 into the RAM 412. The CPU 410 separates the I-FAX image and the header from the received e-mail. Alternatively, the CPU 410 generates transmission e-mail including the I-FAX image and the header. Furthermore, the CPU 410 inputs non-text image information (hereinafter a “regular image”) or an I-FAX image to an e-mail conversion unit 423 and reciprocally converts the regular image and the I-FAX image under a prescribed encoding scheme (for example, base 64 of the MIME). The regular image in the fifth preferred embodiment is in a tiff format.

A display unit 414 of the MFP 401 includes an LCD panel. An operation unit 415 includes various function keys using a hard key and a soft key. The soft key is arranged on a touch screen arranged on the display unit 414 by the CPU 410. The CPU 410 controls the display unit 414. For example, the display unit 414 displays an operational status of the MFP 401, an input instruction for the user, and an image indicating a position of the soft key arranged on the operation unit 415. A user of the MFP 401 operates various function keys of the operation unit 415 while looking at the display unit 414.

The user inputs destination information into the MFP 401 by operating the operation unit 415. For example, the destination information is a FAX number or an e-mail address to be used by the CPU 410 at step S412 of a file storage processing described hereinafter. The destination information is destination information of a transmission destination or a transmitter which is required to store an image file and a communication file in the file server 403, among transmission destinations or transmitters of a FAX image (e-mail for the I-FAX communication). The input destination information is memorized in the EEPROM 413. Further, the destination information may be memorized previously in the ROM 411 or memorized in the RAM 412. The MFP 401 may memorize destination information of a transmission destination or a transmitter which is not required to store an image file and a communication file in the file server 403. Alternatively, an image file and a communication file relating to all transmission destinations or transmitters may be stored in the file server 403. As another example, a user may select whether or not to store the image file and the communication file each time.

A scanner unit 419 of the MFP 401 optically scans an image of an original document set at an image scanning position of the scanner unit 419. The MFP 401 also includes an image memory 421, which includes a DRAM and memorizes a regular image and/or a FAX image. The MFP 401 includes a CODEC 420, an NCU 417 and a MODEM 418. The CODEC 420 carries out an encoding of the regular image and a decoding of the FAX image under a prescribed encoding scheme. The NCU 417 controls the telephone line P. The MODEM 418 transmits and receives a FAX image to and from a FAX machine (not illustrated) via the telephone line P. A printer unit 422 of the MFP 401 includes an electrophotographic printer device and a paper feed device which feeds paper to the printer device. The printer unit 422 forms an image on printing paper in accordance with the regular image memorized in the image memory 421.

The file server 403 includes a CPU 430, a ROM 431, a RAM 432, an I/F 433 and an HDD 434. The file server 403 is connected to the LAN 404 via the I/F 433. The file server 403 is connected to the MFP 401 and PCs 405, 405 and so forth via the LAN 404. The CPU 430 uses the RAM 432 as a working area. The CPU 430 controls each component of the file server 430 in accordance with a control program and data memorized in the ROM 431 and/or the HDD 434 and executes various processes.

When receiving a FAX image (e-mail for I-FAX communication), the CPU 410 of the MFP 401 generates a communication file of communication history information relating to the received FAX image (e-mail for I-FAX communication). The CPU 410 decodes the FAX image (I-FAX image included in the e-mail) by the CODEC 420 (the e-mail conversion unit 423) and generates an image file of the regular image. Furthermore, the CPU 410 generates identification information (for example, “fax1”) which identifies a pair of the generated communication file and the image file. Then, the CPU 410 provides the generated identification information as a file name, excluding an extension, of each of the communication file, which is a csv file, and the image file, which is a tiff file. (In this case, a file name of the communication file is “fax1.csv” and a file name of the image file is “fax1.tif”.)

The CPU 410 communicates with the file server 403 via the I/F 416. The CPU 410 generates a folder 4341 having the identification information as the folder name in the HDD 434 (in this case, the folder name is “fax1”). The CPU 410 transmits the communication file and the image file, which have been assigned with a file name, to the file server 403 and stores into the generated folder 4341.

When the FAX image (e-mail for I-FAX communication) is transmitted, the CPU 410 generates a communication file of communication history information relating to the transmitted FAX image (e-mail for I-FAX communication). The regular image before being encoded into the FAX image (I-FAX image included in e-mail) at transmission of the FAX image is memorized in the image memory 421. Therefore, the CPU 410 generates an image file of the regular image memorized in the image memory 421. The CPU 410 generates identification information (for example, “fax2”) which identifies a pair of the generated communication file and the image file. The CPU 410 provides the generated identification information as a file name, excluding an extension, of each of the generated communication file and the image file. (In this case, a file name of the communication file is “fax2.csv” and a file name of the image file is “fax2.tif”.)

The CPU 410 communicates with the file server 403 via the I/F 416. The CPU 410 generates a folder 4342 having the identification information as a folder name in the HDD 434 (in this case, the folder name is “fax2”). The CPU 410 transmits the communication file and the image file, which have been assigned with a file name, to the file server 403 and stores into the generated folder 4342.

That is, the HDD 434 of the file server 403 memorizes a plurality of folders 4341, 4342 and so forth having the identification information identifying a pair of the communication file and the image file as a folder name. Each of the folders 4341, 4342 and so forth respectively stores a pair of a communication file and an image file, which have the identification information as a file name excluding an extension.

In the following, a description will be made of the FAX communication.

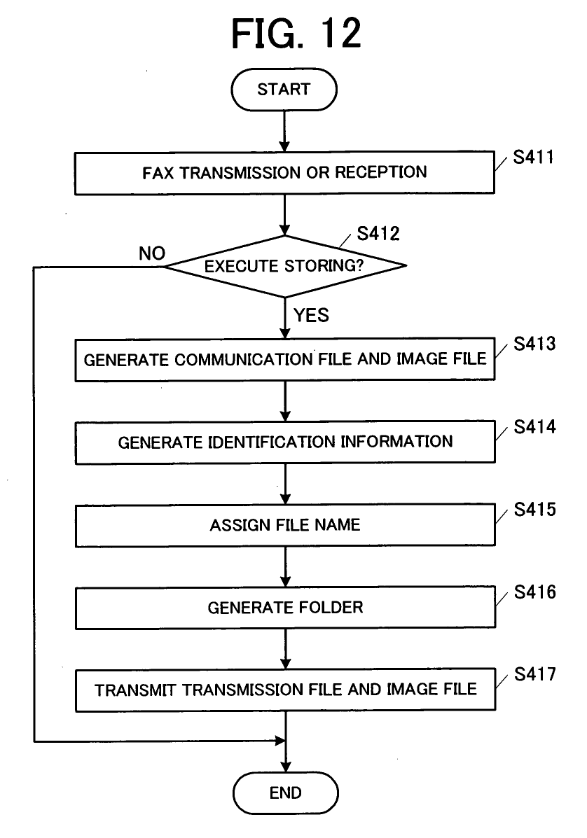

FIG. 12 is a flowchart illustrating a procedure of a file storage processing executed by the CPU 410. The CPU 410 carries out a transmission or a reception of a FAX image by the FAX communication (step S411).

When transmitting a FAX image, for example, the user sets an original document at a document scanning position of the scanner unit 419. The user inputs destination information by operating the operation unit 415. The CPU 410 controls the scanner unit 419 to optically scan an image of the set original document to generate a regular image. The CPU 410 memorizes the generated regular image into the image memory 421. Next, the CPU 410 inputs the regular image, which is memorized in the image memory 421, into the CODEC 420, and the regular image is converted into a FAX image. Lastly, the CPU 410 transmits the converted FAX image to a remote FAX machine having the input destination information by using the NCU 417 and the MODEM 418.

When receiving a FAX image, the CPU 410 receives the FAX image from a remote FAX machine by using the NCU 417 and the MODEM 418. The CPU 410 inputs the received FAX image into the CODEC 420 and the FAX image is converted into a regular image. Then, the CPU 410 memorizes the converted regular image into the image memory 421. The CPU 410 inputs the regular image memorized in the image memory 421 into the printer unit 422 and an image is formed on printing paper.

The CPU 410 determines whether or not to store an image file and a communication file relating to the transmitted or the received FAX image into the file server 403 (step S412). At step S412, the CPU 410 determines whether or not the EEPROM 413 memorizes destination information of a transmission destination, to which the FAX image has been transmitted, or destination information of a transmitter, which has transmitted the FAX image. When the destination information is memorized, the CPU 410 determines to store the image file and the communication file in the file server 403.

When a determination is made to store the image file and the communication file in the file server 403 (step S412: YES), the CPU 410 generates the communication file and the image file and stores the communication file into the RAM 412 and stores the image file into the image memory 421 (step S413). Next, the CPU 410 generates identification information (for example, “fax1”) (step S414). As a file name, excluding an extension, of each of the image file stored in the image memory 421 and the communication file stored in the RAM 412, the CPU 410 assigns the identification information generated at step S414 (step S415). The CPU 410 communicates with the file server 403 and generates a folder (for example, the folder 4341) having the identification information as a folder name (step S416). As a result of the process of step S416 by the CPU 410, the CPU 430 of the file server 403 generates the folder in the HDD 434.

After the process of step S416 has been completed, the communication file and the image file, which have assigned with the file name at step S415, are transmitted to the file server 403 (step S417). As a result of the process of step S417 by the CPU 410, the CPU 430 of the file server 403 stores the received communication file and the image file into the folder.

When a determination is made not to store the image file and the communication file in the file server 403 (step S412: NO) or after the process of step S417 has been completed, the CPU 410 ends the file storage processing. Even when a determination is made at step S412 not to store the image file and the communication file in the file server 403, a communication file may be generated and memorized in, for example, the RAM 412. The identification information generated at step S414 may be notified to the user by, for example, displaying on the display unit 414, printing out onto printing paper, or transmitting e-mail to a communication device (for example, the PC 405) used by the user. Alternatively, instead of generating the identification information, the identification information may be input by the user.

The MFP 401 in the file storage processing functions as a file generating device which generates a file of transmitted and/or received image information and a file of communication history information relating to a transmission and/or a reception result of the image information. The file server 403 functions as a file memory unit which memorizes the files. The CPU 410 at step S415 functions as a naming unit which names the files by including identical identification information identifying the image information and the communication history information into a file name, excluding an extension, of each of the file of the image information and the file of the communication history information. Furthermore, the CPU 410 at step S417 functions as an output unit for outputting the files, which have been named by the naming unit, to the file memory unit.

The CPU 410 at step S417 functions as an output unit for outputting the files to be output to the file memory unit to a folder, which is arranged in the file memory unit and includes identification information identical with the identification information in the folder name.

When using the file storage system including the MFP 401, for example, the user communicates with the file server 403 by using the PC 405 and searches the folder memorized in the HDD 434 in accordance with the identification information by using the file management software installed in the PC 405. The user browses or acquires the communication file and/or the image file stored in the searched folder 4341, 4342 or the like. In this case, for example, even when the communication file or the image file is moved from the folder 4341, 4342 or the like, since the communication file and the image file are associated by a file name, a desired file can easily be searched and acquired in accordance with the identification information by using the file management software.

The image file is in a tiff format, and the communication file is in a csv format. In addition, the image information and the communication history information are not included in the same file. Therefore, the image information and the communication history information can be used easily.

Further, the folders 4341, 4342 and so forth may be stored in different folders according to date and time, or for each user. For example, when a plurality of MFPs 401, 401 and so forth are connected to the LAN 404, the folders 4341, 4342 and so forth may be stored in different folders for each of the MFPs 401, 401 and so forth or may be stored in a single folder.

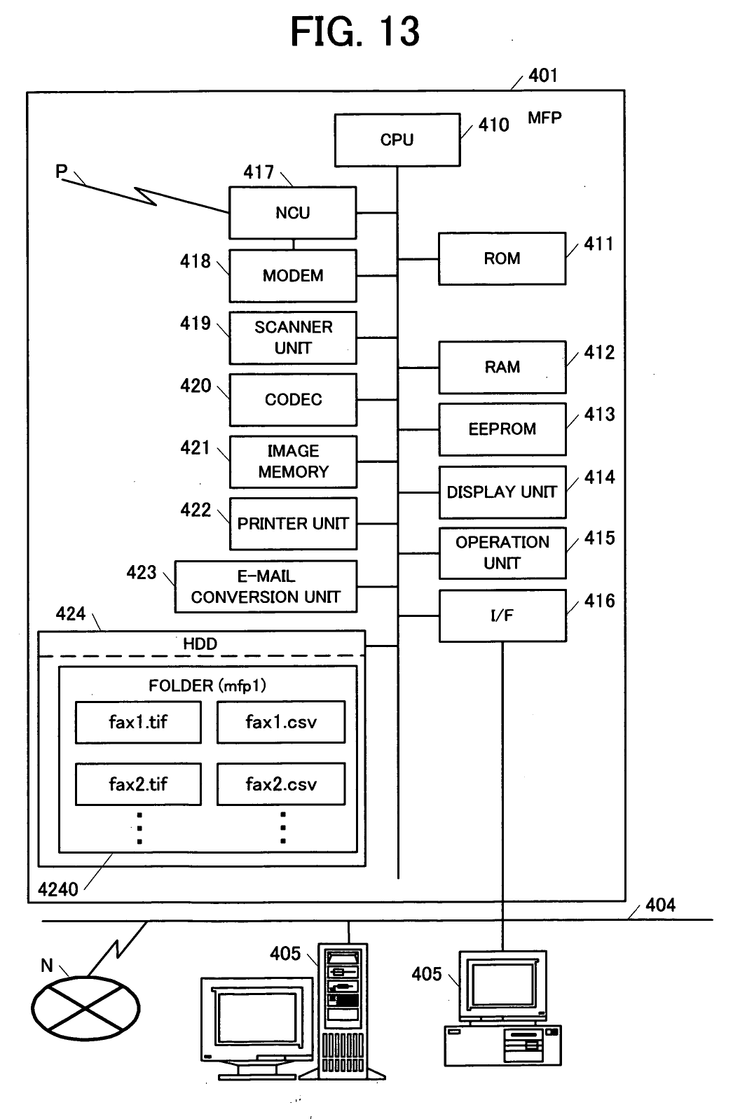

(Sixth Preferred Embodiment) FIG. 13 is a block diagram illustrating a structure of the MFP 401 as a file generating device according to a sixth preferred embodiment of the present invention. The MFP 401 includes an HDD 424. A folder 4240 having an appropriate folder name (for example, “mfp1”) is previously set in the HDD 424. The MFP 401 is connected to the PCs 405 and 405 and the Internet N via the LAN 404.

The user inputs destination information into the MFP 401 by using the operation unit 415. Further, the destination information is used by the CPU 410 for a determination at step S432 of a file storage processing described hereinafter. The destination information is destination information of a transmission destination or a transmitter which is required to store the image file and the communication file. The input destination information is memorized in the EEPROM 413.

When receiving a FAX image, the CPU 410 of the MFP 401 generates a communication file of communication history information relating to the received FAX image. The CPU 410 decodes the FAX image by the CODEC 420 and generates an image file of a regular image. The CPU 410 generates identification information (for example, “fax1”) which identifies a pair of the generated communication file and the generated image file. The generated identification information is provided as a file name, excluding an extension, of each of the communication file, which is a csv file, and the image file, which is a tiff file. (In this case, a file name of the communication file is “fax1.csv” and a file name of the image file is “fax1.tif”.)

When a FAX image is transmitted, the CPU 410 generates a communication file of communication history information relating to the transmitted FAX image. The regular image before being encoded into the FAX image at transmission of the FAX image is memorized in the image memory 421. Therefore, the CPU 410 generates an image file of the regular image memorized in the image memory 421. The CPU 410 generates identification information (for example, “fax2”) which identifies a pair of the generated communication file and the generated image file. The generated identification information is provided as a file name, excluding an extension, of each of the generated communication file and the generated image file. (In this case, a file name of the communication file is “fax2.csv” and a file name of the image file is “fax2.tif”.)

The CPU 410 stores the communication file and the image file, which have been assigned with the file name, into the folder 4240 of the HDD 424. That is, the folder 4240 stores a plurality of pairs of the communication file and the image file.

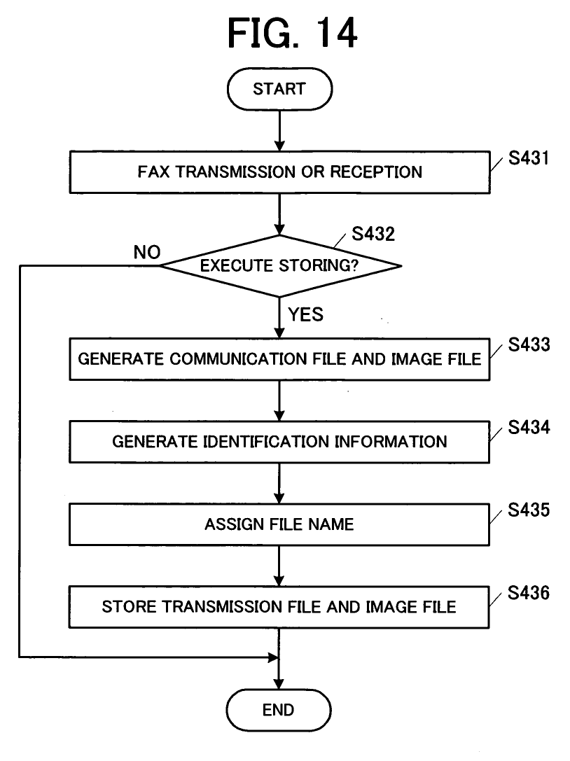

FIG. 14 is a flowchart illustrating a procedure of the file storage processing executed by the CPU 410. The processes of steps S431 through S435 illustrated in FIG. 14 are substantially the same as the processes of steps S411 through S415 illustrated in FIG. 12. Therefore, a description of steps S431 through S435 will be omitted. However, at step S432, the CPU 410 determines whether or not to store the image file and the communication file relating to the transmitted or received FAX image into the folder 4240.

After the process of step S435 has been completed, the CPU 410 stores the communication file and the image file, which have been assigned with a file name at step S435, into the folder 4240 (step S436). When a determination is made not to store the image file and the communication file into the folder 4240 (step S432: NO), or after the process of step S436 has been completed, the CPU 410 ends the file storage processing.

The MFP 401 in the file storage processing functions as a file generating device which generates a file of the transmitted and/or received image information and a file of the communication history information relating to the transmission and/or the reception result of the image information. The HDD 424 functions as a file memory unit which memorizes a file. The CPU 410 at step S435 functions as a naming unit which names the files by including identical identification information identifying the image information and the communication history information into a file name, excluding an extension, of each of the file of the image information and the file of the communication history information. The CPU 410 at step S436 functions as an output unit for outputting the files, which have been named by the naming unit, to the file memory unit.

The CPU 410 at step S436 functions as an output unit for outputting the files to be output to the file memory unit to a specific folder arranged in the file memory unit.

Like numerals are applied to parts corresponding to the fifth preferred embodiment, and a description will be omitted.

When using the file storage system including the MFP 401, for example, the user communicates with the MFP 401 by using the PC 405, and searches the communication file and/or the image file memorized in the folder 4240 of the HDD 424 in accordance with the identification information by using the file management software installed in the PC 405. Then, the user browses or acquires the searched communication file and/or the searched image file. In this case, for example, even when the communication file or the image file is moved from the folder 4240, since the communication file and the image file are associated by the file name, a desired file can easily be searched and acquired in accordance with the identification information by using the file management software. Since the communication file and/or the image file are memorized in the folder 4240, the user may search just the folder 4240. As a result, the search process is light.

Moreover, the image file is in a tiff format, and the communication file is in a csv format. In addition, the image information and the communication history information are not included in the same file. Therefore, the image information and the communication history information can be used easily.

Further, in the fifth and the sixth preferred embodiments, the communication file and the image file may have a file name not coinciding completely but including identical identification information (for example, “fax1-c.csv” and “fax1-t.tif”). Also in this case, each file can easily be searched and acquired in accordance with the identification information (in this case, “fax1”).

A communication file and an image file may be stored in different folders. Communications files and image files may be stored in a specific folder, respectively. Also in this case, each file can easily be searched and acquired in accordance with the identification information.

The communication history information may include a user ID of a transmitter who has transmitted a FAX image by using, for example, an authentication function. Further, the authentication function is a function used for determining whether or not the user is permitted to use the MFP 401.

A journal may be generated by extracting and collecting communication history information included in each of a plurality of communication files and a file name (or identification information) of each of the communication files. The user uses the PC 405 to search the communication history information of desired image information by opening the generated journal, and to search and acquire the desired image information in accordance with the file name (or identification information) of the communication file corresponding to the searched communication history information.

A file to be stored may be compressed. Furthermore, an image file may be generated by the scanner unit 419, and also, an image file may be received from the PC 405.

In the sixth preferred embodiment, for example, when a plurality of MFPs 401 and 401 and so forth are connected to the LAN 404, different folders 4240 and 4240 and so forth may be provided for each of the MFPs 401 and 401 and so forth.

While the present invention has been described with respect to preferred embodiments thereof, it will be apparent to those skilled in the art that the disclosed invention may be modified in numerous ways and may assume many embodiments other than those specifically set out and described above. Accordingly, it is intended by the appended claims to cover all modifications of the present invention that fall within the true spirit and scope of the invention.

What is claimed is:

1. An image communication device, comprising:
a transmission unit which carries out a transmission of image data to a prescribed destination;
an archive transmission unit which carries out an archive transmission of the image data, which has been transmitted by the transmission unit to the destination, to a remote archive device; and
an archive processing control unit which suspends a transmission of the image data when receiving a transmission instruction of the image data under a state in which the archive transmission unit cannot carry out the archive transmission.

2. The image communication device according to claim 1, further comprising a notification unit which notifies a user that the transmission of the image data is suspended when the archive processing control unit suspends the transmission of the image data.

3. The image communication device according to claim 1, further comprising:
an original document scanning unit which scans an original document and generates image data;
a data memory unit which memorizes the image data generated by the original document scanning unit; and
an accepting unit which accepts a setting of either one of a first mode, in which the image data generated by the original document scanning unit is memorized into the data memory unit, and a second mode, in which the image data is not memorized into the data memory unit;
wherein the archive processing control unit suspends the transmission of the image data when the accepting unit accepts the setting of the second mode.

4. The image communication device according to claim 3, wherein when the accepting unit accepts the setting of the second mode, the archive processing control unit suspends the transmission of the image data and determines whether or not to switch to the first mode, and when the second mode can be switched to the first mode, the archive processing control unit instructs to switch to the first mode and cancels the suspension of the transmission of the image data.

5. The image communication device according to claim 1, further comprising a user authentication unit which carries out a user authentication,
wherein when receiving the transmission instruction of the image data under a state in which an archive processing cannot be executed, the archive processing control unit suspends the transmission of the image data and determines whether or not the user authentication unit has authenticated a user, and when the user has been authenticated, the archive processing control unit cancels the suspension of the transmission of the image data.

6. The image communication device according to claim 3, further comprising a user authentication unit which carries out a user authentication,
wherein when receiving the transmission instruction of the image data under a state in which an archive processing cannot be executed, the archive processing control unit suspends the transmission of the image data and determines whether or not the user authentication unit has authenticated a user, and when the user has been authenticated, the archive processing control unit cancels the suspension of the transmission of the image data.

7. The image communication device according to claim 4, further comprising a user authentication unit which carries out a user authentication,
wherein when receiving the transmission instruction of the image data under a state in which an archive processing cannot be executed, the archive processing control unit suspends the transmission of the image data and determines whether or not the user authentication unit has authenticated a user, and when the user has been authenticated, the archive processing control unit cancels the suspension of the transmission of the image data.

8. The image communication device according to claim 1, wherein when the prescribed destination is the archive device, the archive processing control unit determines that an archive processing cannot be executed.

9. An image communication device, comprising:
a transmission unit which carries out a transmission of image information;
a saving unit which saves the image information; and
a saving executing unit which saves the image information to be transmitted by the transmission unit in the saving unit before the transmission unit transmits the image information.

10. The image communication device according to claim 9, further comprising an acquiring unit which acquires the image information saved in the saving unit after the saving executing unit has saved the image information in the saving unit, wherein the transmission unit transmits the image information acquired by the acquiring unit.

11. The image communication device according to claim 9, comprising:
a determination unit which determines whether or not the transmission unit has completed the transmission; and
a deletion executing unit which deletes the image information saved in the saving unit when the determination unit determines that the transmission has not been completed.

12. The image communication device according to claim 10, comprising:
a determination unit which determines whether or not the transmission unit has completed the transmission; and
a deletion executing unit which deletes the image information saved in the saving unit when the determination unit determines that the transmission has not been completed.

13. The image communication device according to claim 9, comprising:
a determination unit which determines whether or not the transmission unit has completed the transmission; and
a movement executing unit which moves the image information saved in the saving unit to a storage unit, which is different from the saving unit and stores image information yet to be transmitted, when the determination unit determines that the transmission has not been completed.

14. The image communication device according to claim 10, comprising:
a determination unit which determines whether or not the transmission unit has completed the transmission; and
a movement executing unit which moves the image information saved in the saving unit to a storage unit, which is different from the saving unit and stores image information yet to be transmitted, when the determination unit determines that the transmission has not been completed.

15. An image communication device, comprising:
a communication unit which carries out a transmission and/or a reception of image information;
an output unit which outputs the image information via a communication line to a remote saving unit, which saves the image information; and
a connection determination unit which determines whether or not a connection is established with the communication line;
wherein when the connection determination unit determines that the connection is not established with the communication line, the transmission and/or the reception of the image information by the communication unit is prohibited.

16. The image communication device according to claim 15, wherein when the connection determination unit determines that the connection with the communication line is established, before the communication unit transmits the image information, the image information to be transmitted by the communication unit is output to the saving unit.

17. The image communication device according to claim 15, further comprising a scanning unit which carries out a scanning of an original document and obtains image information,
wherein when prohibiting the transmission of the image information by the communication unit, the scanning of the original document by the scanning unit is prohibited.

18. An image communication device, comprising:
a file generating unit which generates a file of transmitted and received image information and a file of communication history information relating to a transmission and reception result of the image information;
a naming unit which names the file by including identical identification information, which identifies the image information and the communication history information, into a file name, excluding an extension, of each of the file of the image information and the file of the communication history information; and
an output unit which outputs the file named by the naming unit to a file memory unit which memorizes the file.

19. The image communication device according to claim 18, wherein the output unit outputs the file, which is to be output to the file memory unit, to a specific folder provided in the file memory unit.

20. The image communication device according to claim 18, wherein the output unit outputs the file, which is to be output to the file memory unit, to a folder, which is provided in the file memory unit and includes a folder name having identification information identical to the identification information.
